(19) United States
(12) Patent Application Publication
(10) Pub. No.: US 2014/0109834 A1
(43) Pub. Date: Apr. 24, 2014

(54) Pet Rest

(71) Applicant: Gregory Ronald Hora, (US)

(72) Inventor: Gregory Ronald Hora, (US)

(21) Appl. No.: 13/654,708

(22) Filed: Oct. 18, 2012

(51) Int. Cl. A01K 29/00

(52) U.S. Cl. 119/28.5

(57) ABSTRACT

Pet rests having straps configured to removably couple to furniture legs or poles are disclosed. Pet rests can comprise a soft and flexible fabric and straps having one or more of a gripping material, a fastener, and an adjuster.

This application is a continuation-in-part of application Ser. No. 13/449,311, filed on Apr. 18, 2012, which claims priority from provisional application No. 61/519,178, filed on May 18, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is pet rests, and more specifically pet rests that removably couple with furniture, and even more specifically pet rests that removably couple with furniture legs.

### BACKGROUND

Pet owners commonly purchase items that are specially designed for their pets. Items that are specifically designed for pets include pet beds, pet huts, pet sofas, pet sleeping bags, and pet sofa beds. These items, however, often take up valuable space and create clutter or a tripping hazard.

One type of item specifically designed for pets is a cat hammock. Some examples of cat hammocks can be found in U.S. Design Pat. Nos. D431,695 to Burt, D379,682 to Raffat, D127,808 to Mcgillicuddy, U.S. Pat. No. 5,860,389 to Caldwell, and www.catabove.com. These cat hammocks, however, can be problematic because they each appear to require a very specific support frame.

Some devices that attempt to provide more versatility exist. However, these devices do not appear to have been intended for pets, and have various other limitations. For example, U.S. Patent Publication No. 2011/0043007 to Jones discloses a book hammock that can be installed onto student chairs. However, Jones requires that the chairs have angled legs and apparently cannot be installed on other items of furniture having non-angled legs.

Another example of a non-pet device can be found in U.S. Pat. No. 1,297,431 to Andrew. Andrew discloses a receptacle that can be disposed beneath a seat of a chair to store hats, packages, or other portable articles. However, Jones appears to require screws and a dowel, as well as modification to a leg of a chair. Thus, Jones fails to provide the type or versatility and convenience that many users find desirable.

U.S. Pat. No. 5,015,033 to Winters and U.S. Pat. No. 5,106,152 to Ward each disclose underseat receptacles. Winters and Ward, however, each fail to provide a receptacle that could be comfortably used by a pet. For example, Winters' receptacle is configured to fit flush against a bottom of a chair, while Ward's receptacle comprises an array of cross-linked strips.

United States Patent Application Publication No. US 2011/0272981 to Rabson discloses a seat cover that can be used to protect a seat from liquids. However, Rabson is apparently not applicable for use under a chair, and comprises straps that are designed to connect to one another rather than a leg.

It has yet to be appreciated that a pet rest can be versatile, portable, and comfortable without unnecessarily taking up excessive amounts of space. Thus, there is still a need for improved pet rests.

### SUMMARY OF THE INVENTION

The inventive subject matter provides apparatus, systems and methods in which one can provide a pet rest that can be removably coupled with one or more legs of various furniture items.

In one aspect of the inventive subject matter, the pet rest comprises a sheet, and two or more straps having at least one of a fastener, strap adjuster, and a gripping material. The sheet design requires no integral support frame. The support for the sheet can come from a user's existing chair, table, or any other suitable furniture item having legs or poles. For example, the straps can be coupled with the legs of a chair so that the sheet is disposed under the chair seat and in between its legs. The pet rest does not require any additional floor space and results in no additional clutter. Since the pet rest is coupled with an item of furniture, a broom or vacuum can easily be moved underneath for cleaning.

By removably coupling the sheet to the chair's legs and situating the sleeping area underneath the chair's seat, a pet will have a covering overhead. This can be desirable to the pet and result in further use of the sheet, and thus, increased buyer satisfaction.

In another aspect of the inventive subject matter, the pet rest can comprise a support frame. This support frame can be located within a fold of the sheet, between two sheets, or in any other suitable area of the pet rest. Contemplated support frames can be removed so that the pet rest can be shipped in a smaller amount of space, resulting in a cost savings to both the retailer and consumer.

In an embodiment of the present inventive subject matter, a sheet for a chair underside is provided and adapted for outstretching. The chair has a first leg, a second leg, a third leg and a seat having an area and an outer perimeter. The sheet comprises an outstretched area not exceeding the seat area, an outer perimeter, and at least three straps. The first strap has a first end and a second end, the first end of the first strap being attached to a first attaching point disposed on the outer perimeter of the sheet, the second end of the first strap being removably coupled to the first leg of the chair. The second strap has a first end and a second end, the first end of the second strap being attached to a second attaching point disposed on the outer perimeter of the sheet the second end of the second strap being removably coupled to the second leg of the chair. The third strap has a first end and a second end, the first end of the third strap being attached to a third attaching point disposed on the outer perimeter of the sheet the second end of the third strap being removably coupled to the third leg of the chair.

It is contemplated that a strap can be attached to a sheet in any suitable manner (e.g., sewing, gluing, stapling, looping through a perforation, etc.). It is also contemplated that a strap can be coupled to a sheet via a ring, loop, or other device having a perforation. For example, a sheet can comprise a perforation configured to accept one or more key-rings, and a strap can be tied around, sewn around, or otherwise coupled with the key ring(s).

In another embodiment of the present inventive subject matter, the chair comprises four legs, and the sheet further comprises a fourth strap having a first end and a second end, the first end of the fourth strap being attached to a fourth attaching point disposed on the outer perimeter of the sheet, the second end of the fourth strap being removably coupled to the fourth leg of the chair.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1A to 1C show a pet rest of the present inventive subject matter coupled with a chair in different views.

FIGS. 2A to 2C show other pet rests of the present inventive subject matter.

FIGS. 3A to 3C show a pet rest having a stiffening bar and coupled with a chair.

FIGS. 4A to 4C show a pet rest having a side flap and coupled with a chair.

FIGS. 5A, 5B and 6 illustrate a pet rest coupled with a three legged chair.

FIG. 7 is a schematic of a pet rest having a gripping material.

FIG. 8 is a schematic of another pet rest having a gripping material.

FIG. 9A to 9C are cross-sectional views of straps coupled with chair legs.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

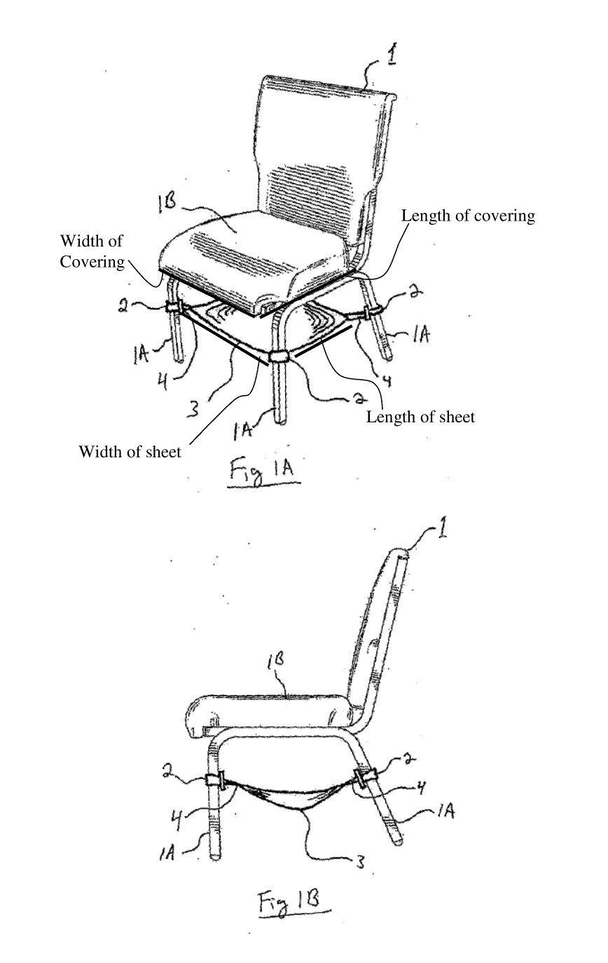

The pet rest of the present invention may be removably coupled to a furniture item having two, three, four, or even five or more legs. One embodiment of a pet rest of the present inventive subject matter installed on a chair having four legs is illustrated in FIG. 1A (isometric view), FIG. 1B (side view), and FIG. 1C (front view).

A strap 4 is removably coupled to the chair leg IA at four attachment points 2 on the chair. One strap will connect to one leg of the chair providing support for the sheet area 3 which may be made of any suitable material, including for example, fabric, plastic, wood, metal, or composites. The attachment point 2 of the sheet strap to the chair leg is accomplished by any suitable means, including any of the following: string, hook and loop connections, buttons, snaps, buckles, zipper, strap, magnets, hooks, or other similar devices.

As shown in FIG. 1A, the area (i.e., length times width) of a sheet can be less than or equal to an area (i.e., length times width) of a bottom portion of a covering. It is also contemplated that the area of a sheet can be greater than the area of a bottom portion of a covering.

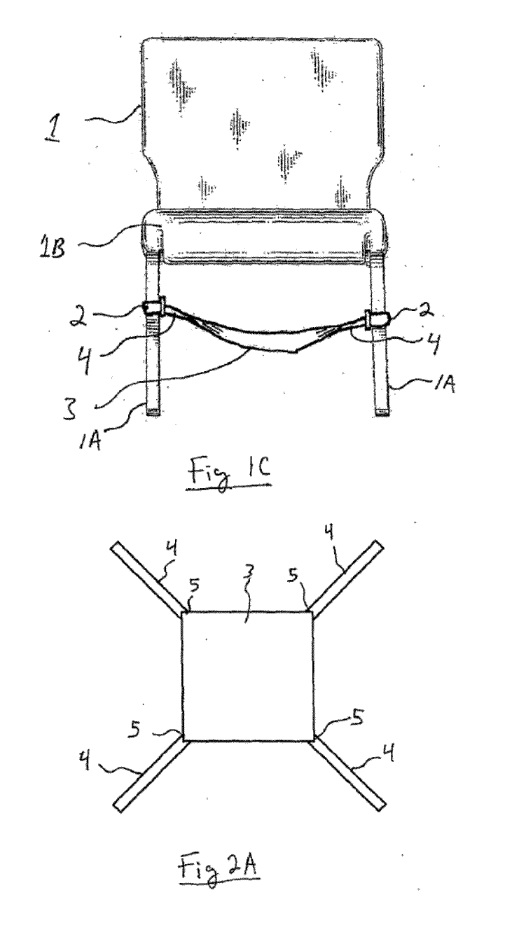

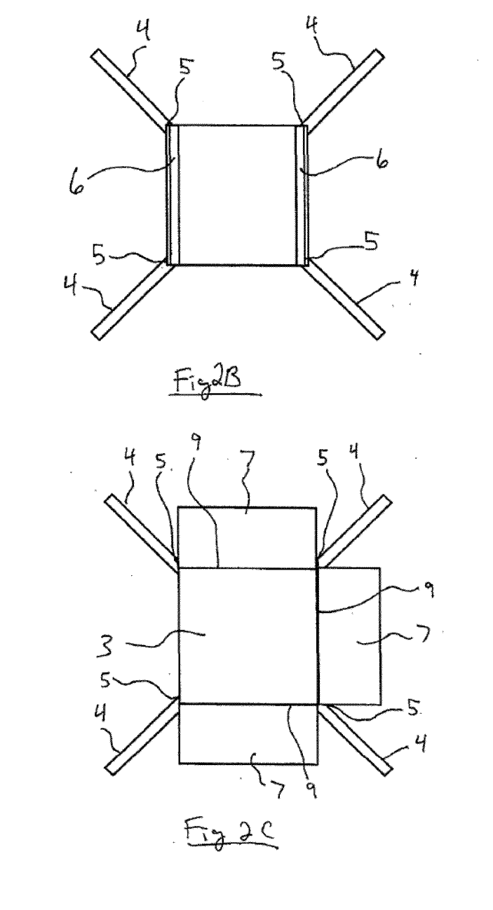

An embodiment of the inventive subject matter is shown by itself in the non-installed state in FIG. 2A. The sheet seating area 3 is of a size sufficient to accommodate a reclined pet. The straps 4 are shown attached to the sheet seating area at the interface point 5.

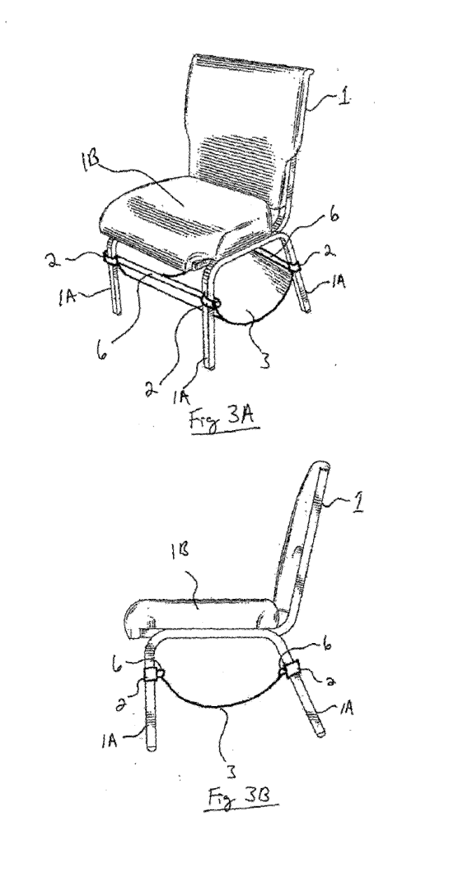

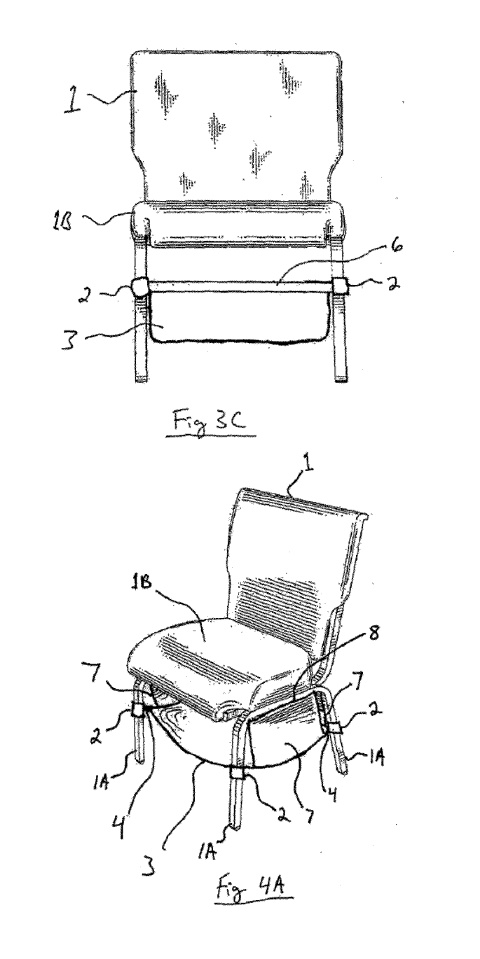

One possible alternate design that utilizes stiffening rods is shown in FIG. 2B. This configuration utilizes stiffening rods 6 (removably, slidably, or permanently) coupled with two opposite sides of the seating area 3. The rods are coupled with the sheet on the entire length of two sides of the seating area 3. The straps 4 and interface point 5 are unchanged from the configuration show in FIG. 2A. These stiffening rods could make it easier for a pet to enter or exit the sheet when installed. The installation of this configuration is shown on FIG. 3A (isometric view), FIG. 3B (side view) and FIG. 3C (front view). Similar to FIG. 1A-1C, the strap 4 is removably coupled with the chair leg IA at the attachment point 2 by any suitable means, including any of the following: string, hook and loop connections, buttons, snaps, buckles, zipper, strap, magnets, hooks, or other similar devices.

As shown in FIGS. 3A and 3B, pet rests can comprise a planar rectangular sheet with four straps attached to the four corners of the sheet. The sheet can comprise a substantially U-shaped droop (when viewed from a side as in FIG. 3B), to provide easy access for a pet. To increase the sturdiness of a sheet between two attachment points, a stiffening bar can be added between attachment points.

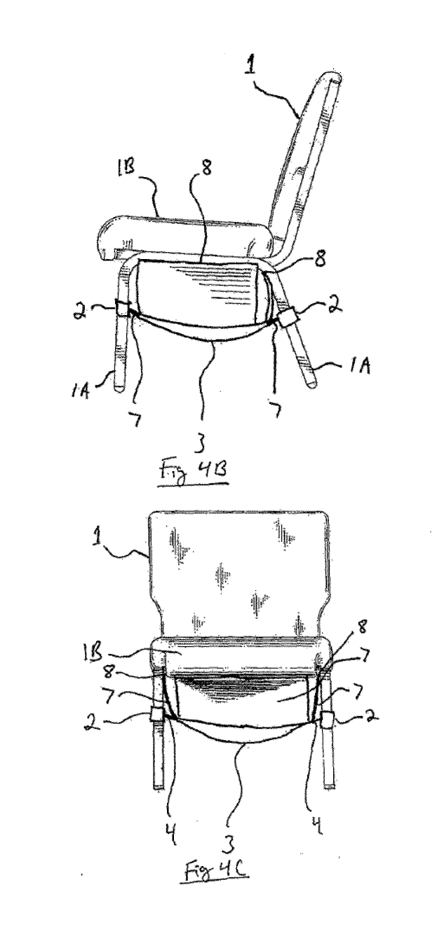

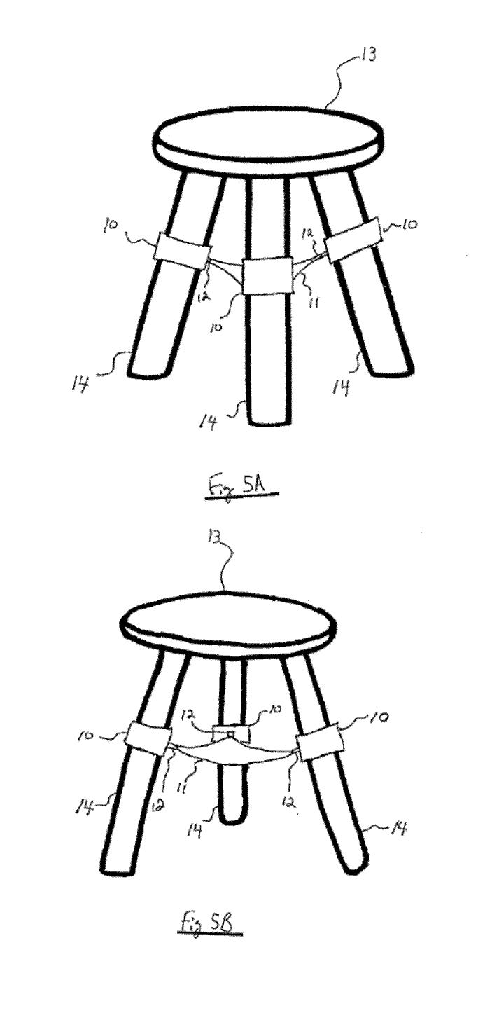

Another possible alternate design that utilizes side flaps is shown in FIG. 2C. This configuration utilizes side straps 7 attached to three sides of the seating area 3 at the strap interface area 9. These side flaps can provide more of an enclosed area for the pet to sit on the seating area 3 when in the installed configuration. An installed configuration is shown in FIG. 4A (isometric view), FIG. 4B (side view) and FIG. 4C (front view). Similar to FIG. 1A-1C, the strap 4 is removably coupled with the chair leg IA at the attachment point 2 by any suitable means, including any of the following: string, hook and loop connections, buttons, snaps, buckles, zipper, strap, magnets, hooks, or other similar devices. The side flaps 7 are removably coupled to the chair at the flap attachment point 8 by any suitable means, including any of the following: string, hook and loop connections, buttons, snaps, buckles, zipper, strap, magnets, hooks, or other similar devices. It is also contemplated that front, rear, or any other suitable flaps could be included to provide an even more enclosed area for the pet.

From the description above, a number of advantages of the pet sheet invention become evident: (a) The simple construction of the sheet eliminates the need for any special support framework by utilizing the inherent frame created by a chair's legs. This eliminates a large cost requirement of typical pet sheets; (b) The space normally wasted underneath a chair is utilized by this invention. Therefore, additional floor space will not be required to utilize a pet sheet in the home; (c) The sheet can be removed from in its installed state on the chair or left in place for cleaning. For cleaning operations such as sweeping or vacuuming of the floor, the sheet can be left coupled to the chair and not present an additional item to be moved as opposed to conventional styles of pet sheets. If desired, the sheet can be removed from the chair for simple cleaning of the fabric; (d) By having a simple design not requiring any framework, the packaging and shipping of the sheet will be more economical for both the manufacturer and consumer; (e) By providing a covered area for a pet to lie, a pet will be more likely to utilize this style of sheet as opposed to an “open air” design of a typical pet sheet without any overhead covering. Therefore, the consumer will be more satisfied with a sheet their pet uses compared to one that the pet does not use very often.

The manner in which any pet rest of the inventive subject matter is installed can be the same for any of the previously mentioned designs. The main seating area of the sheet can be placed underneath of the chair and in between the chair legs. The seating area of the sheet can be placed equidistant from all four legs resulting in an equal amount of sheet strap to be available for coupling with the chair legs at the attachment point(s). Each of the sheet straps can then be individually coupled at the attachment point(s) of the chair legs at a level below the chair seat to allow sufficient access to the sheet by the pet.

The installation of a design utilizing the side flaps (or other flaps) can follow the previous installation instructions with the following addition: once the sheet straps are removably coupled with the chair legs at the attachment point(s), each side flap can be installed to the chair at the flap attachment point (e.g., FIG. 4A-4C, reference numeral 8).

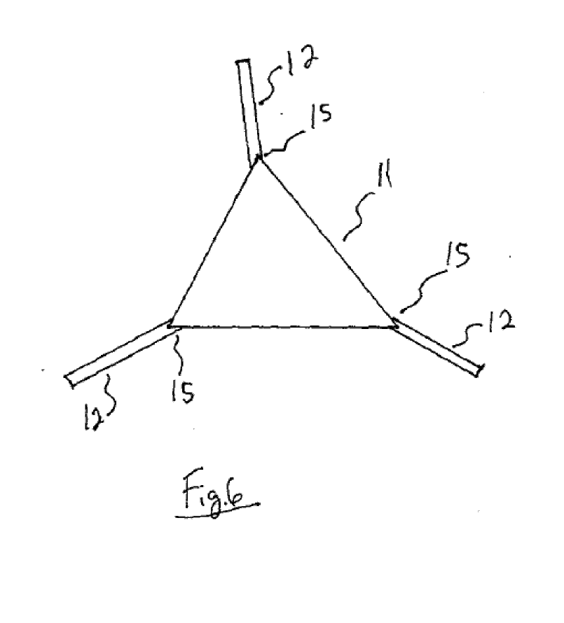

In an alternate embodiment shown in FIGS. 5A, 5B and 6, a sheet 11 is removably coupled to legs 14 of a three legged chair 13 using strap 12 and attachment patch 10 at interface point 15.

Accordingly, the reader will see that the configuration of this pet sheet invention will allow the user to save space in their home by using the wasted space underneath their existing chairs. Through the simple installation, the user will have the flexibility to use the sheet on virtually any type of chair with four legs. The cost will also be greatly reduced for both the manufacturer and consumer by eliminating the dedicated support structure of the sheet.

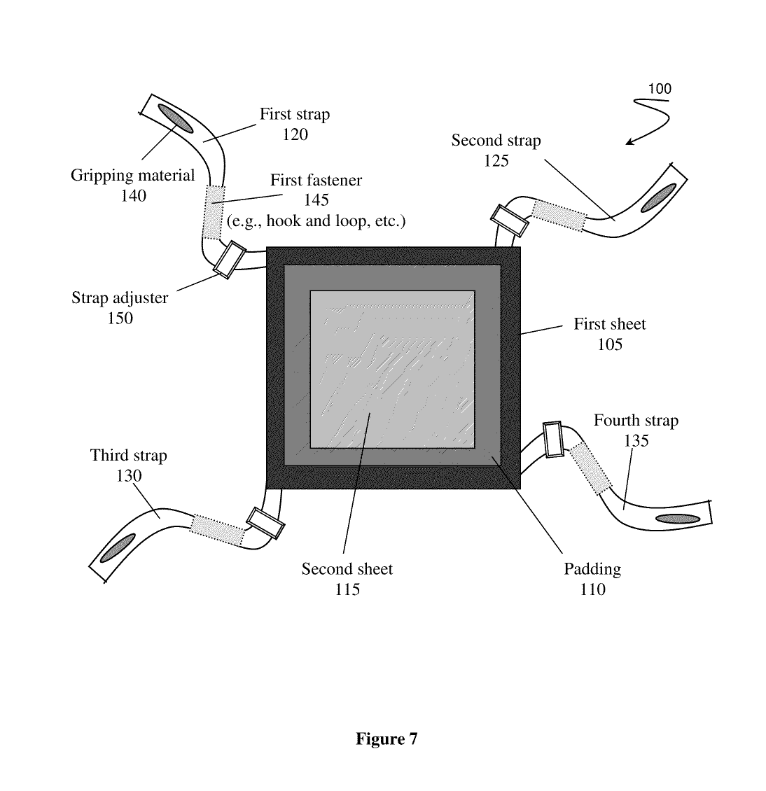

FIG. 7 shows another embodiment of the inventive subject matter. Pet rest 100 comprises a first sheet 105, padding 110, and second sheet 115. Each of the first sheet 105 and optionally included second sheet 115 can be made of any suitable material, including for example: (a) wool, fleece, cotton, polar fleece, nylon, polyester, leather, or any other soft and flexible material; or (b) a plastic, polypropylene, wire, metal, or any other harder material. Some contemplated sheets can be machine washable (i.e., washed with a washing machine without shrinking or otherwise damaging the sheet beyond normal wear and tear). Padding 110 is optionally included and can comprise any suitable padding, including for example, foam, feathers, or gel. Pet rest 100 further comprises first strap 120, second strap 125, third strap 130, and fourth strap 135. Each of the straps is separate from one another and can comprise at least one of a suitable fastener (e.g., first fastener 145), a strap adjuster 150, and gripping material 140.

As used herein, the term “gripping material” is used broadly to include any material that can be added to or incorporated into a strap to increase a coefficient of friction of the straps and thereby reduce or prevent slipping. Exemplary gripping materials include, for example, silicone, rubber, and any other commercially suitable materials. Specific examples of suitable gripping materials include EGRIPS® material by Flexible Innovations, Ltd., and 3M Material GM400, GM110, GM631, GM630, GM614, GM73, and GM641.

The gripping material is preferably included on one or more of the straps of a pet rest so that the pet rest can be used on furniture legs or poles that are at any angle relative to a covering (e.g., seat of a chair, or table top, etc.), including for example, 45°, 90°, or 135°. Without the addition of gripping material, a pet rest would not be suitable for use on furniture having legs or poles that are perpendicular (e.g., 90°) or acute (e.g., extending inwardly) to a covering, as the straps would easily slide down the leg over time. By adding or incorporating gripping material to the straps, the coefficient of friction of the strap can be increased to provide a substantial or complete non-slip friction fit with a leg, even where the leg is perpendicular or at an acute angle to the covering or ground, and even when a pet is lying therein.

It is contemplated that gripping material, fasteners and adjusters can be located along any portion of a strap or sheet. For example, a pet rest can comprise two straps attached to a sheet. One strap can comprise a gripping material on one side, and a fastener (e.g., a button) on the opposite side. The second strap can comprise loops on one side, and gripping material and hooks on the opposite side.

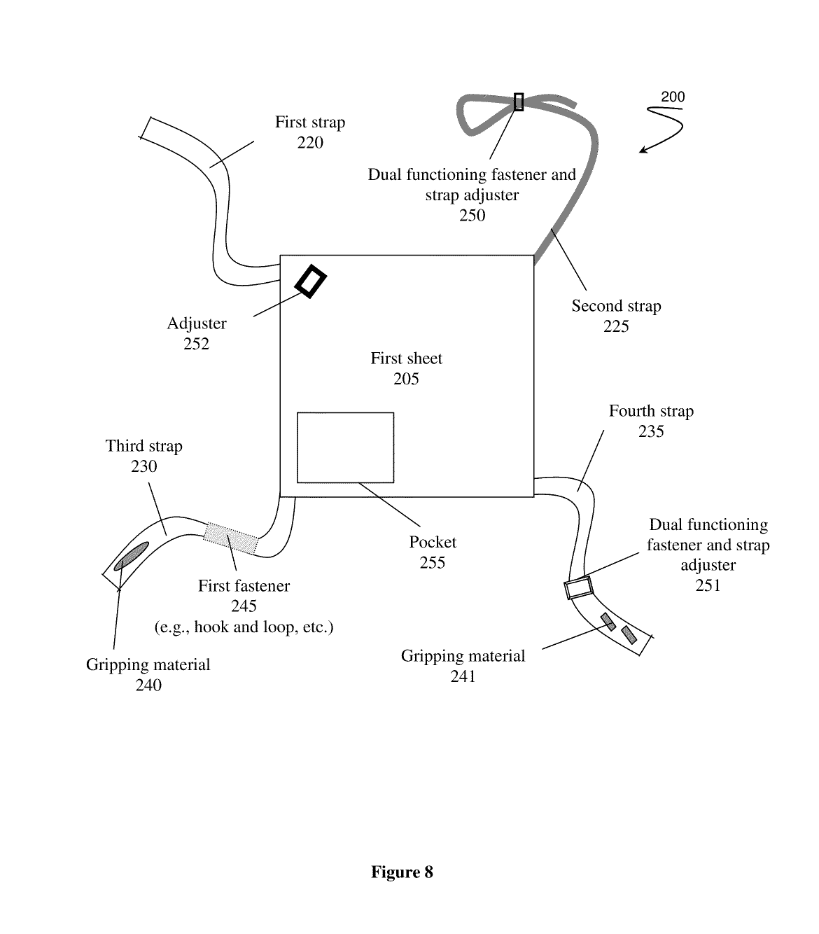

FIG. 8 shows another embodiment of the inventive subject matter. Pet rest 200 comprises a first sheet of material 205 having a pocket 255, a first strap 220, second strap 225, third strap 230, and fourth strap 235. Pocket 255 can be an open pocket, or comprise any suitable fastener, such as a zipper, a button, or a hook and loop fastener. First strap 220 is a simple strap that can simply be tied into a knot around a leg or pole. Thus, first strap can 220 act as a fastener. Additionally or alternatively, first strap 220 can be inserted through adjuster 252 (e.g., a sewn in loop, etc.), which is coupled to sheet 205. In such embodiments, a strap can be threaded through an adjuster coupled with a sheet, and then be removably coupled with a fastener. Second strap 225 comprises a dual functioning fastener and strap adjuster 250. Strap 225 can be wrapped around a leg of a table, slid through fastener and adjuster 250, then tightened or loosened as desired. It is contemplated that strap 225 can comprise buttons, snaps, hooks and loops, notches, buckles, or any other commercially suitable fasteners that can lock strap 250 at a desired tightness until loosened by a user. Such notches and buckles could be included in some embodiments to provide a more customized or tighter fit with a leg or pole. Third strap 230 is similar to the straps of pet rest 100, but does not include a strap adjuster. Fourth strap 235 comprises a dual functioning fastener and strap adjuster 251, similar to fastener and adjuster 250, and includes gripping material 241.

A sheet can comprise a soft and flexible material such that the sheet can form a droop when the pet rest is installed. The droop is preferably at a mid-portion of the sheet or sheets, and can be 1, 2, 5, 10, or even 12 or more inches below a corner or an edge of the sheet when the pet rest is installed.

A single sheet can comprise one, two, or even three or more different types of materials. Thus, a single sheet can have two or more materials sewn together so that a thickness of one material juxtaposes a thickness of a second material. For example, a square sheet that is 16 inches by 12 inches can comprise: (1) a leather rectangular frame that is two inches thick; and (2) a fluffy wool mid-section that is 12 inches by 8 inches.

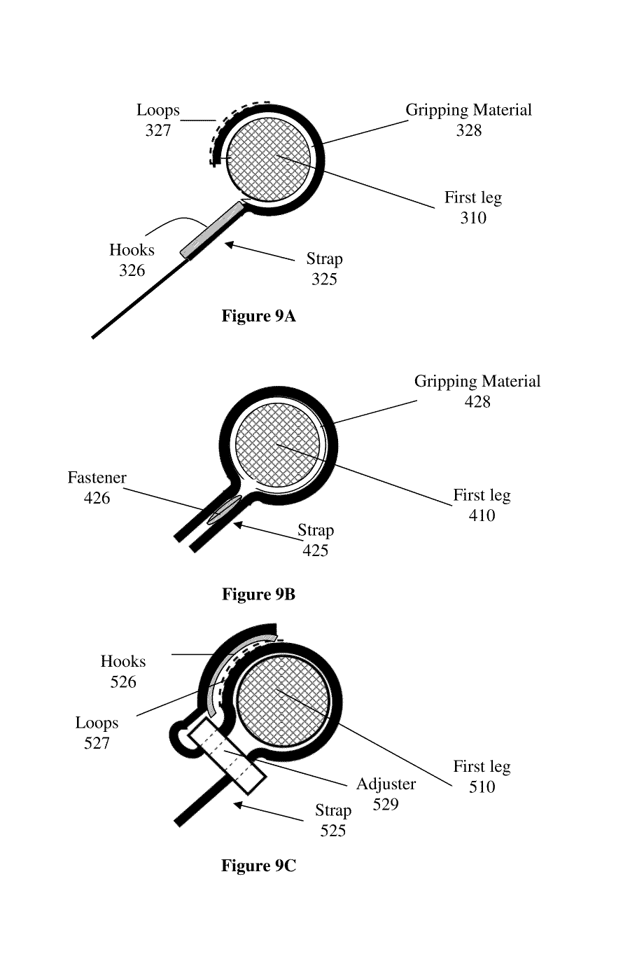

FIGS. 9A-9C show three different straps, each coupled with a leg of a chair. Strap 325 comprises gripping material 328 and hooks 326 on a first side, and loops 327 on the opposite side. Strap 325 is configured to wrap around first leg 310 such that gripping material 328 touches first leg 310, and hooks 326 can removably attach to loops 327. Strap 425 comprises a fastener 426, and gripping material 428. Fastener 426 comprises two pieces configured to snap fit with one another. One of the fastener pieces is located on one side of gripping material 428, while another fastener is located on the other side of gripping material 428. Thus, strap 425 can wrap around a portion of first leg 410 and lock in place via fastener 426. Strap 525 comprises an adjuster 529, hooks 526, and loops 527. In this embodiment, strap 525 is configured to wrap around a portion of first leg 510, thread through and around adjuster 529, and lock in place via an attachment of hooks 526 with loops 527.

Contemplated pet rests can comprise any suitable number of sheets, padding, straps, fasteners, adjusters, gripping materials, or any other component. It is contemplated that each pet rest can be configured to hold 10, 20, 30, 40, or even 100 or more pounds when coupled with furniture legs or poles. Moreover, each of the sheets and straps can be of any suitable shapes (e.g., triangular, rectangular, circular, oval, oval having one or two truncated sides, truncated triangle, a compound shape, or any other suitable shape) and sizes. For example, a planar rectangular sheet can be 12 by 12 inches, 10 by 14 inches, 10 by 20 inches, 20 by 20 inches, or any other suitable dimensions. Each strap that is attached to the sheet can be 5, 10, 15, or even 20 or more inches long. Thus, a pet rest can be configured to couple with furniture items having legs or poles that are spaced out by 10, 18, 27, or even 45 or more inches.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A pet rest for use under an item of furniture having a first leg and a second leg, comprising:
a first sheet, a first strap, and a second strap;
wherein the first strap has a first end portion and a second end portion;
wherein the first end portion is attached to the first sheet;
wherein the second end portion is configured to removably couple with the first leg; and
wherein the second end portion comprises a gripping material.

2. The pet rest of claim 1, wherein the second strap has a third end portion and a fourth end portion.

3. The pet rest of claim 2, wherein the third end portion is attached to the first sheet, wherein the fourth end portion is configured to removably couple with to the second leg, and wherein the fourth end portion comprises a gripping material.

4. The pet rest of claim 1, wherein at least one of the first and second straps is adjustable.

5. The pet rest of claim 1, wherein the sheet is made of a machine washable material.

6. The pet rest of claim 1, further comprising a second sheet different from the first sheet, wherein the second sheet overlies at least a portion of the first sheet.

7. The pet rest of claim 1, wherein the first sheet comprises a fleece material.

8. The pet rest of claim 1, further comprising a foam padding that overlies at least a portion of the first sheet.

9. The pet rest of claim 1, further comprising a pocket coupled to the first sheet.

10. A pet rest for use under an item of furniture having first, second, third and fourth legs, comprising:
a first rectangular sheet having a first, second, third and fourth corner;
a first strap attached to the first corner;
a second strap attached to the second corner;
a third strap attached to the third corner;
a fourth strap attached to the fourth corner; and
wherein the first, second, third and fourth straps each comprise a fastener and a gripping material, and
wherein the first, second, third and fourth straps are configured to removably couple with the first, second, third and fourth legs, respectively.

11. The pet rest of claim 10, further comprising a second sheet that substantially overlies the first sheet.

12. The pet rest of claim 10, wherein at least one of the first, second, third and fourth straps is adjustable.

13. The pet rest of claim 10, wherein the sheet is configured to droop at a mid-portion when the first, second, third and fourth straps are removably coupled with the first, second, third, and fourth legs.

14. The pet rest of claim 13, wherein a bottom-most portion of the droop is at least 1 inch below the first corner.

15. The pet rest of claim 10, further comprising a pocket coupled to the first sheet.

16. The pet rest of claim 10, wherein the gripping material comprises at least one of silicone and rubber.

17. The pet rest of claim 10, wherein the fastener comprises at least one of hooks and loops, a snap, and a button and perforation.

18. The pet rest of claim 10, wherein the first sheet is machine washable.

19. The pet rest of claim 10, wherein the first sheet comprises at least one of a wool and a polar fleece.

20. The pet rest of claim 10, wherein the gripping material comprises a gripping pattern.
